(19) United States
(12) Patent Application Publication
(10) Pub. No.: US 2012/0054282 A1
(43) Pub. Date: Mar. 1, 2012

(54) ARCHITECTURE AND METHOD FOR HYBRID PEER TO PEER/CLIENT-SERVER DATA TRANSMISSION

(75) Inventors: Chung-Wei Lin, Changhua City (TW); Lun-Chia Kuo, Taichung (TW); Jen-Hsiao Wen, Taichung (TW); Yu-Jung Yeh, Hsinchu (TW)

(73) Assignee: INDUSTRIAL TECHNOLOGY RESEARCH INSTITUTE, Hsinchu (TW)

(21) Appl. No.: 12/904,403

(22) Filed: Oct. 14, 2010

(30) Foreign Application Priority Data
Aug. 27, 2010 (TW) 099128924

(51) Int. Cl. G06F 15/16

(52) U.S. Cl. 709/205

(57) ABSTRACT

Architecture and method of hybrid P2P/client-server for data transmission involve using a P2P grouping method to determine the data transmission mode being a P2P mode or a client-server mode by an original source, for a plurality of peers connected to the original source. The original source further divides the plurality of peers into a P2P group and a client-server group, and dynamically determines the respective number of peers and the upstream bandwidth for the two groups. Thereby, during a data transmission procedure, it may achieve a performance balance among the propagation delay, restriction of upstream bandwidth for data sources, network throughput and system loading.

### TECHNICAL FIELD

The present disclosure generally relates to an architecture and method for hybrid peer-to-peer (P2P)/client-server data transmission.

### BACKGROUND

For an internet service, such as, multimedia streaming, file download, etc., the network bandwidth and the packet delay time are the important parameters that may affect quality-of-service (QoS). The data transmission based on client-server architecture may reduce the propagation delay, but requires much higher upload bandwidth on the server side. In addition, the higher the upload bandwidth is rented, the higher the operation cost is. The data transmission based on the P2P architecture does not require higher upload bandwidth on the server side, but will cause longer propagation delay. For time-sensitive applications, the propagation delay prohibits the real-time viewing of multimedia contents. For file download applications, reducing the propagation delay will enable more files to arrive before the deadline or to reduce the rented upload bandwidth.

FIG. 1 shows an exemplary schematic view of a hierarchical hybrid P2P/client-server data transmission architecture, where the dash line indicates the transmission direction of stream data. In FIG. 1, first layer 101 extends from a central server, such as, control server 110 to a plurality of edge servers, such as, a plurality of streaming servers 111-114. First layer 101 is a client-server overlay for data delivery. Layer 102 extends from edge servers to a plurality of peers with P2P data delivery. Take streaming server 111 as example. Data transmission from streaming server 111 to three end-user clients 121-123 is in P2P mode. The architecture in FIG. 1 requires relay edge servers and signaling to assist in data transmission.

FIG. 2 shows an exemplary schematic view of hybrid P2P client-server architecture for file download applications. In FIG. 2, the message exchange, such as, index or identify, between a plurality of peers, marked as 221-225, and a central server 210 belong to client-server architecture. The file transfer between peers is based on P2P mode.

FIG. 3 shows an exemplary schematic view of a hybrid P2P tree/mesh overlay for data delivery. In the exemplary tree-mesh P2P architecture 300 of FIG. 3, the hexagon represents a network node, single-headed arrow represents the tree overlay, segment with two terminal ends represents mesh overlay, and single-headed arrow indicates the pull data. For data delivery, hybrid tree-mesh P2P architecture 300 first uses a tree-push mechanism to rapidly fill the buffer of peers with data. Then, if missing data block is detected, such as, missing data block 304 in mesh pull window 314, a mesh-pull mechanism is used to obtain the remaining data block. Streaming data 302 is transmitted via a P2P mode.

FIG. 4 shows an exemplary schematic view of a dual reception mode of a client in a hybrid P2P data streaming. In FIG. 4, a first buffer 412 and a second buffer 414 receive respectively from at least a P2P network and at least a server over a client-server network. In this hybrid P2P delivery overlay, the data source of peers may be from nearby peers or original data source, and the original data source may also be seen as a peer. Based on own status of playback buffer 416, a peer may determine how to receive the data streams from first buffer 412 and second buffer 414.

### SUMMARY

The exemplary embodiments of the present disclosure may provide an architecture and method for hybrid peer-to-peer (P2P)/client-server data transmission.

In an exemplary embodiment, the disclosed relates to an architecture for hybrid peer-to-peer (P2P)/client-server data transmission, applicable to a data delivery system. The architecture comprises an original source and a plurality of peers connected to the original source for transmitting and/or receiving data, wherein the original source determines whether the data transmission modes of the plurality of the connected peers are P2P mode or client-server mode, and divides the plurality of connected peers into a P2P group and a client-server group. Then, the original source dynamically determines the number of peers of each group and adjusts the available upload bandwidth and/or download bandwidth for each group.

In another exemplary embodiment, the disclosed relates to a method for hybrid peer-to-peer (P2P)/client-server data transmission, applicable to a data delivery system. The method comprises: an original source determining whether the data transmission modes of a plurality of the connected peers being P2P mode or client-server mode via a peer grouping method, and dividing the plurality of connected peers into a P2P group and a client-server group; and during a data transmission process, the original source dynamically determining the number of peers of each group and adjusting the available upload bandwidth and/or download bandwidth for each group via computing a system performance index, to achieve the balance of the performance of the data delivery system.

The foregoing and other features, aspects and advantages of the present disclosure will become better understood from a careful reading of a detailed description provided herein below with appropriate reference to the accompanying drawings.

### BRIEF DESCRIPTION OF THE DRAWINGS

FIG. 1 shows an exemplary schematic view of hierarchical hybrid P2P/client-server architecture for data transmission.

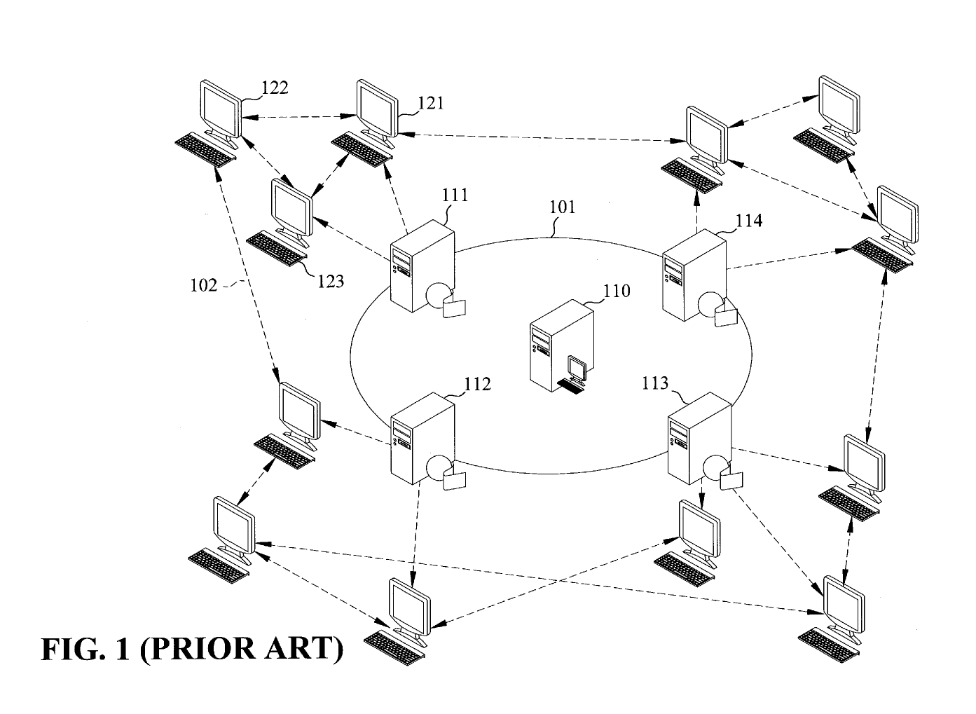

FIG. 2 shows an exemplary schematic view of hybrid P2P client-server architecture for file download applications.

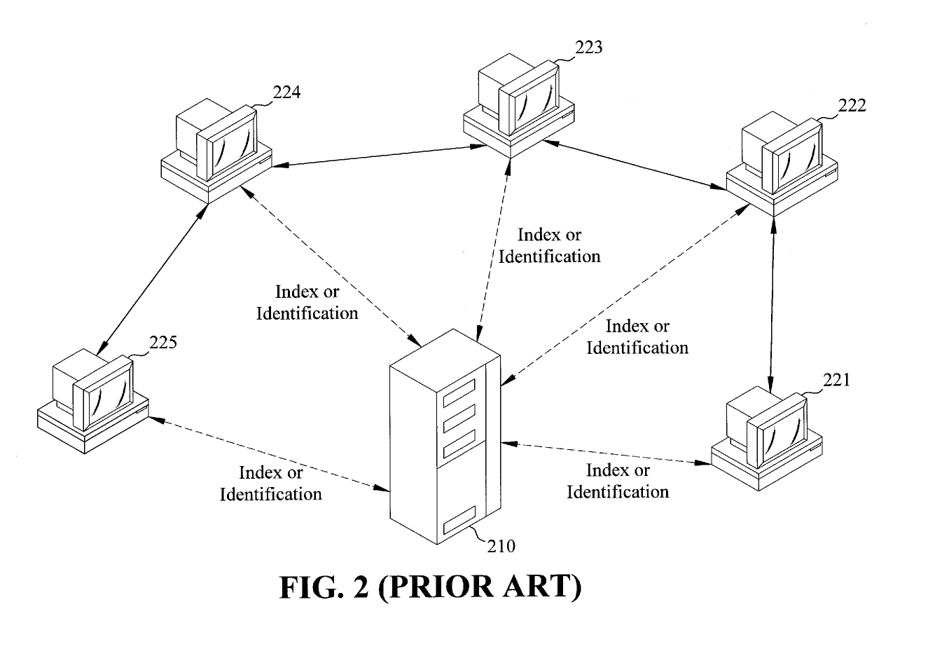

FIG. 3 shows an exemplary schematic view of a hybrid P2P tree/mesh overlay for data delivery.

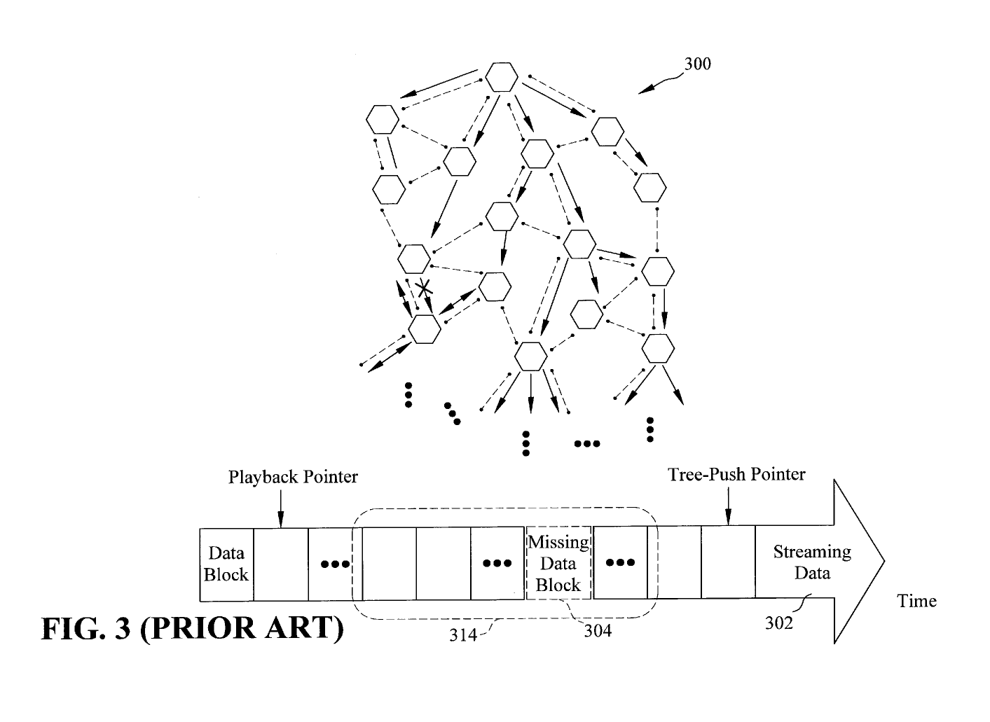

FIG. 4 shows an exemplary schematic view of a dual reception mode of a client in a hybrid P2P data streaming.

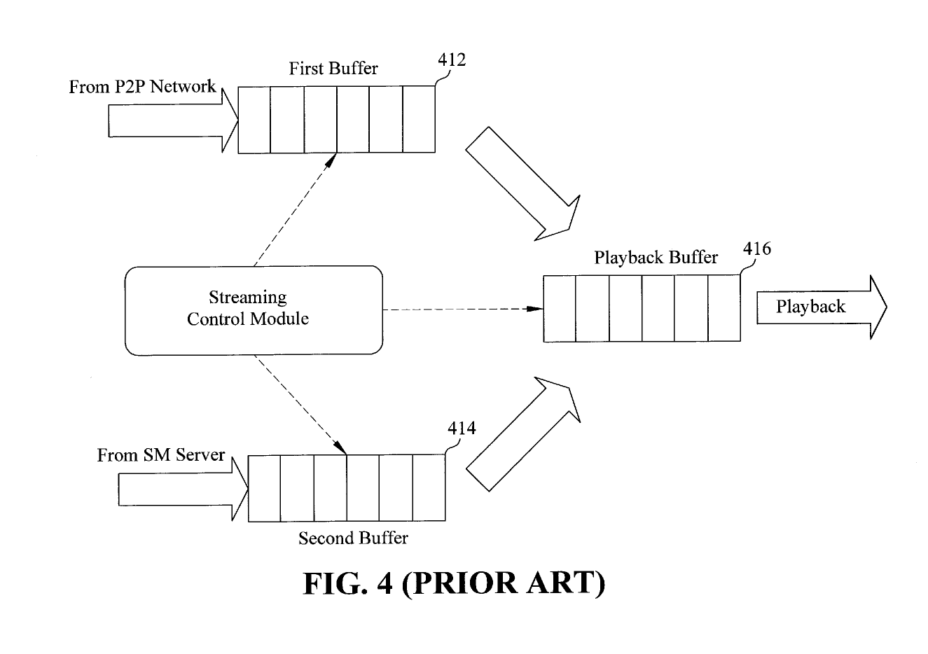

FIG. 5 shows an exemplary architecture for hybrid P2P/client-server data transmission, consistent with certain disclosed embodiments.

FIG. 6 shows an exemplary schematic view of an original source being an embedded device, consistent with certain disclosed embodiments.

FIG. 7 shows an exemplary schematic view illustrating the source of the data segments owned by peers of client-server and P2P groups, consistent with certain disclosed embodiments.

FIG. 8A shows an exemplary schematic view illustrating the relation between system loading and number of peers under different network-topology architectures, consistent with certain disclosed embodiments.

FIG. 8B shows an exemplary schematic view illustrating the relation between transmission delay and number of peers under different network-topology architectures, consistent with certain disclosed embodiments.

FIG. 8C shows an exemplary schematic view illustrating the relation between network throughput and number of peers under different network-topology architectures, consistent with certain disclosed embodiments.

FIGS. 9A-9B show an exemplary flowchart of a peer grouping method, consistent with certain disclosed embodiments.

FIG. 10 shows an exemplary flowchart of a method for hybrid P2P/client-server data transmission, consistent with certain disclosed embodiments.

### DETAILED DESCRIPTION OF THE EXEMPLARY EMBODIMENTS

The disclosed exemplary embodiments design a hybrid P2P/client-server data transmission overlay by using a peer grouping method, in which the original source determines whether the connected peers transmit data in P2P mode or client-server mode. Based on the data transmission mode, the original source divides the peers into two groups, and dynamically determines the number of peers, and adjusts the upload/download bandwidth of each group to achieve a performance balance.

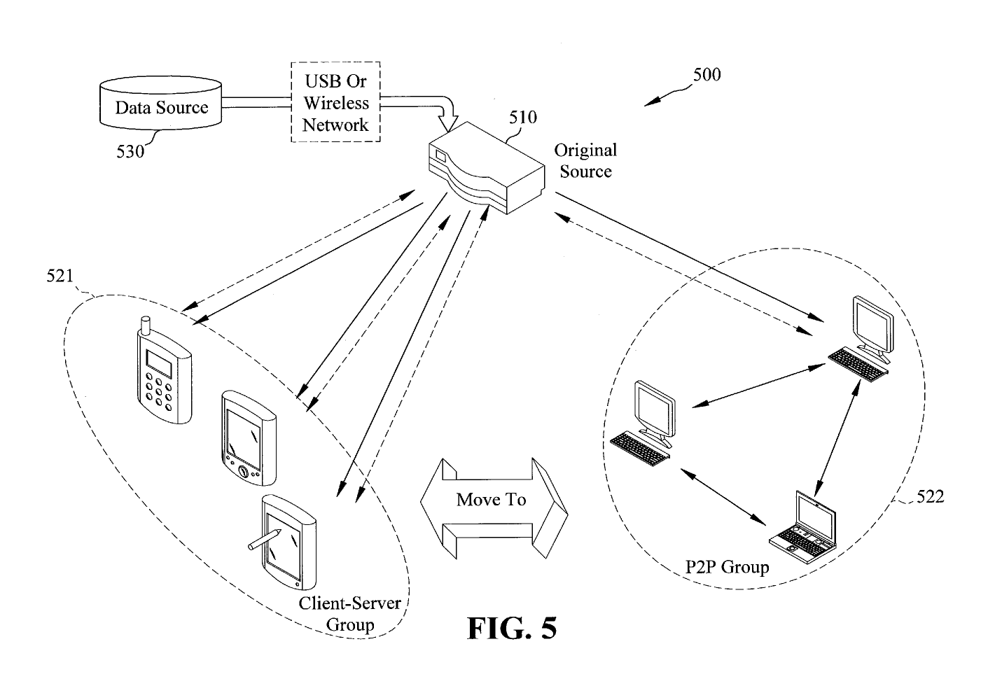

FIG. 5 shows an exemplary architecture for hybrid P2P/client-server data transmission, consistent with certain disclosed embodiments. In FIG. 5, hybrid P2P/client-server data transmission architecture 500 comprises an original source 510 and a plurality of data transmission/receiving peers connected to original source 510. Original source 510 determines whether the connected peers transmit data in P2P mode or client-server mode, and then divides the plurality of connected peers into a client-server group 521 and a P2P group 522. Original source 510 also dynamically determines the number of peers in each group and adjusts the upload/download bandwidth for each group, where the arrow indicates the data transfer and the double arrow indicates the signaling. Data transmission architecture 500 may be applied to a data delivery system. The plurality of data transmitting/receiving peers connected to original source 510 may be, such as, a plurality of heterogeneous devices forming P2P group 522 and client-server group 521.

Original source 510 may be an embedded computing device, or connected via, such as, Universal Serial Bus (USB) or wireless network to a data source 530 having data, such as, web cam or hard disk, and the data from the data source may be transmitted via one or more network interface to P2P group 522 and client-server group 521. The type of data may be a plurality of media, such as, video, audio, images, and so on, and the data may be converted into other format, such as, from MPEG-4 to H.264, via a media format conversion method.

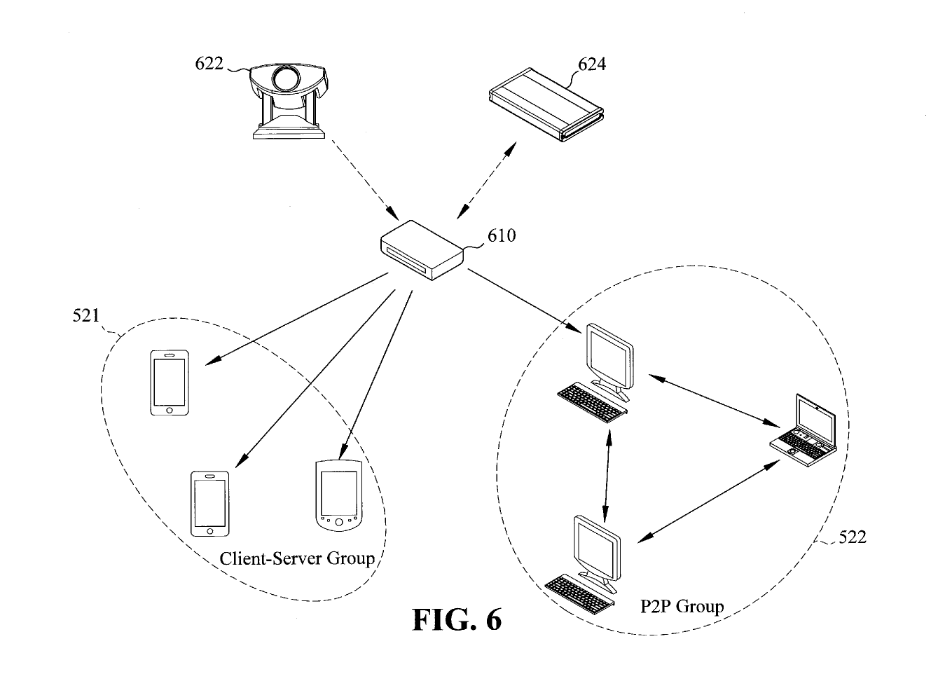

For example, in the embodiment in FIG. 6, original source 510 can be an access point (AP) 610, such as, Wi-Fi AP embedded device. The contents of data transmission by AP 610 may be obtained via various channels, such as, via USB interface connecting to a video conference camera 622 to obtain live image for real-time video service, or from external add-on hard disk 624 to obtain video files for video on demand (VOD) service.

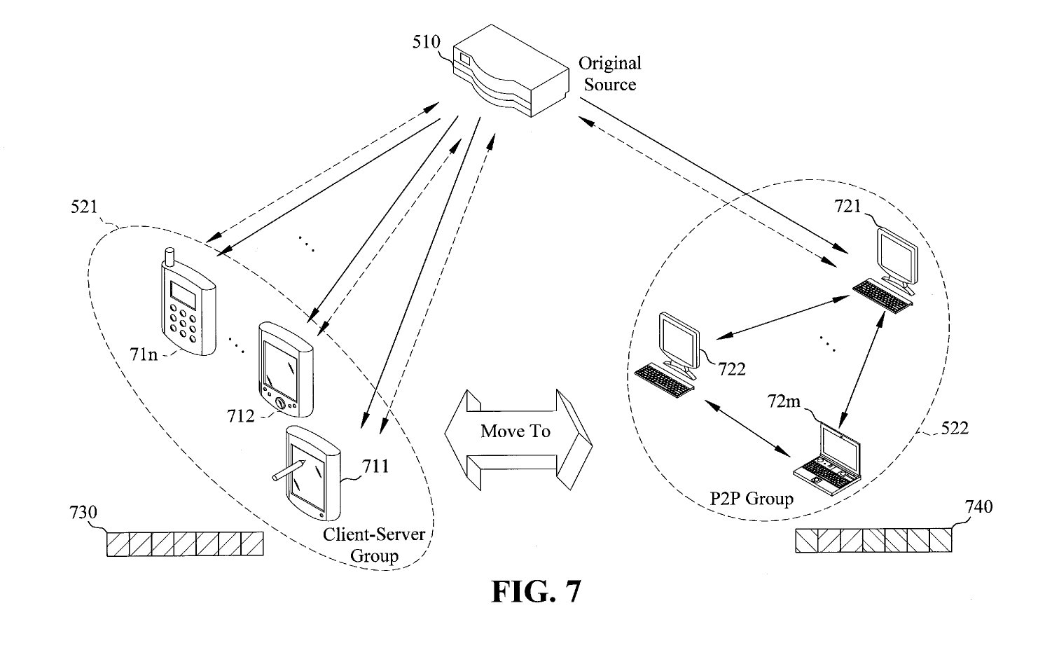

Client-server group 521 may include n peers, n≧0, and P2P group 522 may include m peers, m≧0. When n≧1, as shown in the exemplar in FIG. 7, client-server group 521 includes n peers 711-71n. Each peer downloads or streams the data segment directly from original source 510. In other words, all data segments 730 owned by the peers of client-server group 521 are from original source 510. When m≧1 , P2P group 522 includes m peers 721-72m. Data segment 740 owned by each peer may be from different neighboring peers, or from original source 510, which may be seen as one of the peers. Accordingly, the number of peers connected to original source 510 for data transmitting/receiving is n+m.

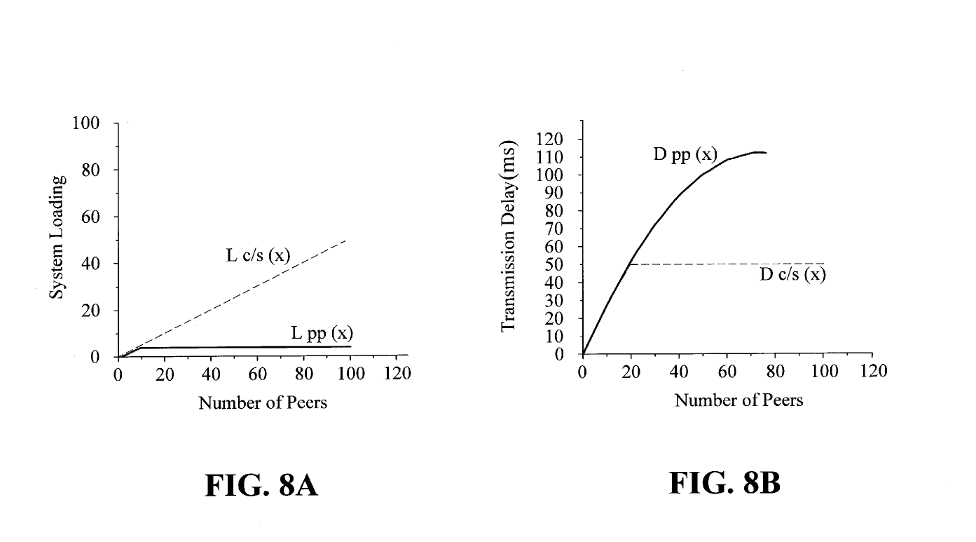

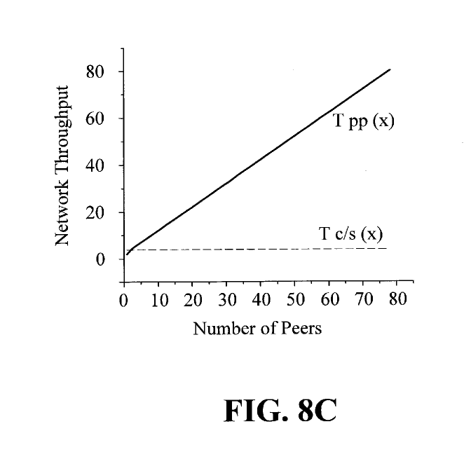

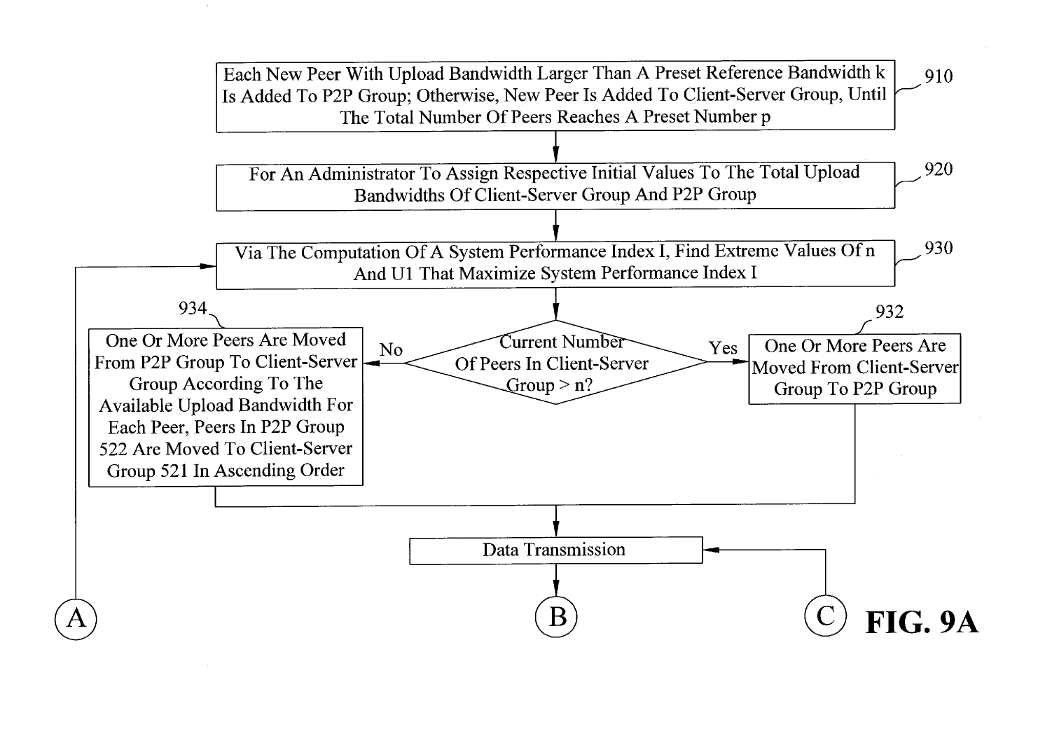

Under different network-topology architectures, the number of peers will be affected by the system loading, transmission delay or network throughput. FIG. 8A, FIG. 8B and FIG. 8C show exemplary schematic views of the relation between the number of peers and system loading, transmission delay and network throughput respectively under client-server topology architecture and P2P topology architecture, wherein x-axis is the number of peers, represented by variable x and the y-axis is system loading, transmission delay and network throughput, respectively. The dash line indicates the client-server architecture and the solid line indicates the P2P architecture. In FIG. 8A, symbols Lpp(x) and Lc/s(x) depict the system loading of P2P architecture and client-server architecture, respectively. In FIG. 8B, symbols Dpp(x) and Dc/s(x) depict the transmission delay of P2P architecture and client-server architecture, respectively. In FIG. 8C, symbols Tpp(x) and Tc/s(x) depict the network throughput of P2P architecture and client-server architecture, respectively.

In the exemplars of FIG. 8A, FIG. 8B and FIG. 8C, such as, in the client-server architecture, as the number of peers increases, the system loading also increases, shown as Lc/s(x) of FIG. 8A. Because original source 510 directly transmits to each peer, the transmission delay will maintain roughly at a fixed length if only the effect of network topology on the transmission delay is taken into account, shown as Dc/s(x) of FIG. 8B. Then, because the bandwidth share mechanism is used, the total upload bandwidth is fixed, thus, the total network throughput also maintains at a fixed level, shown as Tc/s(x) of FIG. 8C.

In the P2P architecture, each peer may play the role of data source provider; therefore, as the number of peers increases, the system loading does not increase at the original source, shown as Lpp(x) of FIG. 8A. Because a peer may be located at any position in the P2P topology, the average transmission delay will increase, shown as Dpp(x) of FIG. 8B. Then, because the total upload bandwidth is fixed, thus, the total network throughput will increases by using P2P data transmission, shown as Tpp(x) of FIG. 8C.

Hence, the technology in the present disclosure takes the transmission delay, upload bandwidth limitation of data source, network throughput and system loading of P2P transmission into account and uses peer grouping and switching method to let original source 510 to determine the data transmission mode for all the connected peers, and divides the connected peers into P2P group 522 and client-server group 521. Original source 510 also dynamically determines the suitable number of peers of each group and adjusts the upload/download bandwidth for each group to achieve a performance balance.

Take the hybrid P2P/client-server data transmission architecture of FIG. 5 to explain the network throughput. Assume that client-server group 521 has three peers, and the total upload bandwidth allocated to client-server group 521 and P2P group 522 is U1 and U2, respectively. The initial values of U1 and U2 may be assigned by an administrator, and U1 and U2 may be changed dynamically during the data transmission process. Assume that the initial allocated values of U1 and U2 are 600 Kbps, respectively. In client-server group 521, via bandwidth sharing mechanism, each peer may receive data at about 200 Kbps rate. Therefore, the total network throughput of client-server group 521 is 200 Kbps×3=600 Kbps. On the other hand, in P2Pr group 522, each peer transmits data in P2P mode, thus each peer can receive data at about 600 Kbps rate. Therefore, the total network throughput of P2P group 522 is 600 Kbps×3=1800 Kbps.

The following describe the statistic computation of Dc/s(x) and Dpp(x). In client-server group 521, when original source 510 sends out a packet, current time t1 will be stamped to the packet. When a client receives the packet at time t2 and retrieves the time stamp, i.e., t1, the transmission delay is computed as t2−t1, and the transmission delay is returned directly to original source 510 for statistic computation to obtain Dc/s(x). In P2P group 522, when original source 510 sends out a packet, the current time t3 will be stamped to the packet. When a peer receives the packet at time t4 and retrieves the time stamp, i.e., t3, the transmission delay is computed as t4−t3, and the transmission delay is returned to a super peer in P2P group 522 for statistic computation to obtain Dpp(x). The Dpp(x) value is then returned directly to original source 510 for record.

In other words, in client-server group 521, the transmission delay may be computed by the receiving peer using the time stamp information in the packet and the receiving time of the packet, and the computed result is returned directly to original source 510 for statistic computation to obtain Dc/s(x). In P2P group 522, the transmission delay may be computed by the receiving peer using the time stamp information in the packet and the receiving time of the packet, and the computed result is passed to a super peer in P2P group 522 for statistic computation to obtain Dpp(x). The Dpp(x) value is then returned directly to original source 510 for record.

In P2P group 522, a peer with higher computing power or upload bandwidth may be a super peer. The data segment owned by the super peer may be from original source 510 or any other peer in P2P group 522. The data segment owned by the non-super peer may be from any other peer in P2P group 522

The average transmission delay D1 of client-server group 521 or the average transmission delay D2 of P2P group 522 is related to the number of peers of group, i.e., the number of peers connected to original peer 510. In other words, average transmission delay D1 of client-server group 521 may be expressed as D1=Dc/s(n), and average transmission delay D2 of P2P group 522 may be expressed as D2=Dpp(m). Similarly, the number of peers in client-server group 521 and P2P group 522 is related to the system loading. In other words, system loading L1 of client-server group 521 may be expressed as L1=Lc/s(n), and system loading L2 of P2P group 522 may be expressed as L2=Lpp(m). The system loading, for example, may be the utilization rate of at least a central processing unit (CPU) of original source 510, the utilization rate of at least a physical or virtual memory, number of times of accesses or transmission throughput of hard disk or network card, or a function of any combination of the above.

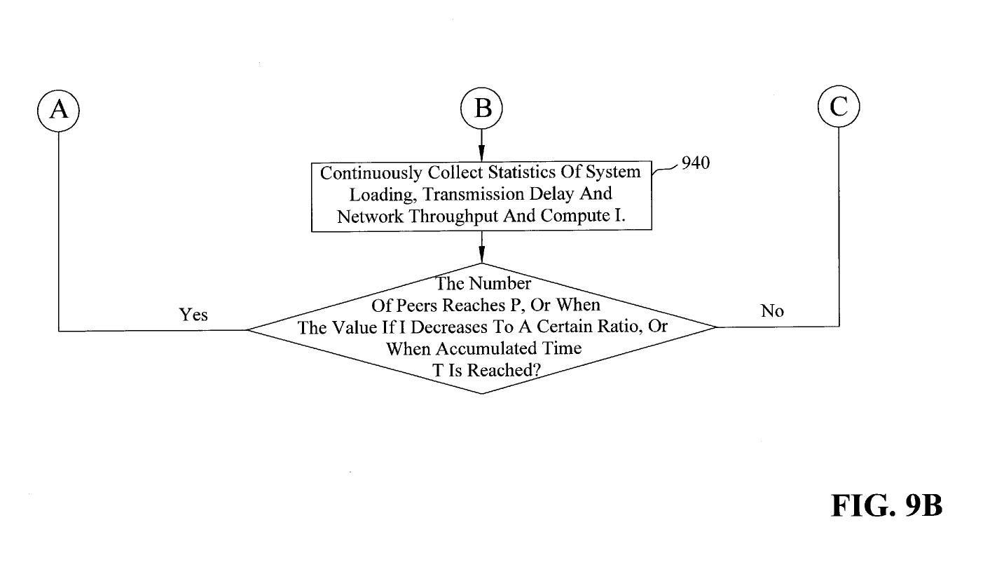

FIGS. 9A-9B show an exemplary flowchart of the peer grouping method, consistent with certain disclosed embodiments. In step 910, each new peer with upload bandwidth larger than a preset reference bandwidth k is added to P2P group 522; otherwise, new peer is added to client-server group 521, until the total number of peers reaches a preset number p. Then, for an administrator, respective initial values are assigned to the total upload bandwidths U1 and U2 of client-server group 521 and P2P group 522, as shown in step 920. Accordingly, the available upload bandwidth for each peer in client-server group 521 is U1/p. The final data transmission rate equals to min{U1/p, Di, u}, where Di is the download bandwidth of each peer and u is the self-determined guaranteed upload bandwidth for each peer of client-server group 521.

As aforementioned, the number of peers in client-server group 521 and P2P group 522 will affect the system loading of original source 510, transmission delay of client-server group 521 and P2P group 522 and network throughput. In step 930, via the computation of a system performance index I, the values of n and U1 that make the system performance index I is maximum may be obtained. The system performance index I is within a range [a, b] having an acceptable system loading rate.

System performance index I may be defined by taking the system loading of original source 510, respective average transmission delay of client-server group 521 and P2P group 522 and total network throughput, and respective number of peers m, n connected to original source 510 into account. The following exemplary equation is used to explain.

$$\begin{matrix}I = total network throughput / total delay \\ = [ Tc / s ( n ) = Tpp ( m ) ] / [ Dc / s ( n ) / U 1 + Dpp ( m ) / U 2 ]\end{matrix}$$

wherein I must satisfy

a<Lc/s(n)+Lpp(m)<b

m+n=T>0, T is the number of peers connected to original source

U1+U2=B, U1, U2>0, B is the total bandwidth of original source.

In this manner, by using, such as, multi-variable function to find extreme values, the extreme values of n (i.e., number of peers in client-server group 521) and U1 (total upload bandwidth assigned to client-server group 521) for maximizing system performance index I may be obtained. After n is obtained, when the current number of peers in client-server group 521 is larger than n, as shown in step 932, one or more peers are moved from client-server group 521 to P2P group 522; for example, according to the available upload bandwidth for each peer, peers in client-server group 521 may be moved to P2P group 522 in descending order. On the other hand, as shown in step 934, one or more peers are moved from P2P group 522 to client-server group 521, for example, according to the available upload bandwidth for each peer, peers in P2P group 522 may be moved to client-server group 521 in ascending order. In other words, the result of the comparison of the value of n and the current number of peers in client-server group 521 determines whether peers are to move from client-server group 521 to P2P group 522 or from P2P group 522 to client-server group 521.

The total upload/download bandwidth required by client-server group 521 and P2P group 522 may be adjusted dynamically. Hence, during data transmission process, the aforementioned statistics of system loading, transmission delay and network throughput are continuously collected and the value of I is computed, as shown in step 940. When the number of peers reaches p, such as, p=10, 20, 30, and so on, or when the value of I decreases to a certain ratio, such as, larger than 1%, or when an accumulated time t is reached, the process of updating n and U1 is executed, i.e., step 930; otherwise, entering the data transmission process and executing step 940.

The following working exemplar further describes the operation flow of FIG. 9. The acceptable system loading range is [0.25, 0.5] because when the loading is too high the system is easy to break down and when the loading is too low, the system resource is wasted. Assume that the total bandwidth at original source B=10, and before updating n and U1, the following statistical functions and parameters are obtained:

Lc/s(n)=0.05·n, Lpp(T−n)=0.1, Dc/s(n)=10, Dpp(T−n)=(−0.1·(T−n)²+1.5·(T−n)),

Tc/s(n)=U1, Tpp(T−n)=(T−n)·(B−U1)

The figures corresponding to the aforementioned system loading, transmission delay and network throughput equations are similar to the exemplars in FIG. 8A, FIG. 8B and FIG. 8C, and thus are omitted here.

When there are 20 peers, i.e., T=20, the process of updating n and U1 is activated. At this point, system performance index I is:

$$I = \frac{U 1 + ( 20 \text{-} n ) \cdot ( 10 \text{-} U 1 )}{\frac{10}{U 1} + \frac{( - 0.1 \cdot {( 20 - n )}^{2} + 1.5 \cdot ( 20 - n ) )}{10 - U 1}}$$

wherein 0.25≦0.05n+0.2≦0.5, 0≦n≦20, i.e., 1≦n≦20.

When U1=7 and n=3, I has the maximum value. Hence, client-server group 521 should maintain 3 peers, with assigned bandwidth=7 Mbps. Assume that prior to adjustment, client-server group 521 has 7 peers. In this case, four peers with better computation powers will be selected to move to P2P group 522.

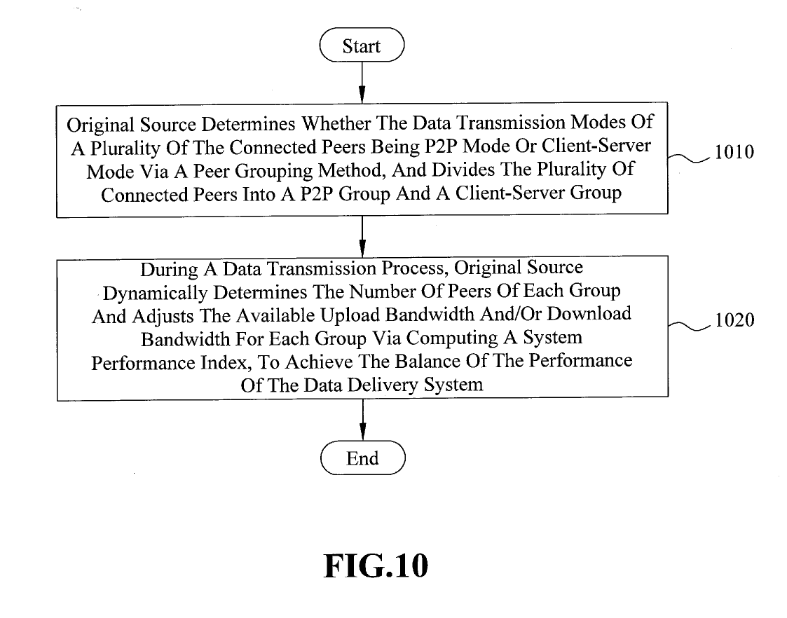

FIG. 10 shows an exemplary flowchart of method for hybrid P2P and client-server data transmission, consistent with certain disclosed embodiments. The method for hybrid P2P and client-server data transmission is applicable to a data delivery system. Referring to FIG. 10, original source 510 determines whether the data transmission modes of a plurality of the connected peers being P2P mode or client-server mode via a peer grouping method, and divides the plurality of connected peers into a P2P group and a client-server group, as shown in step 1010. During a data transmission process, original source 510 dynamically determines the number of peers of each group and adjusts the available upload bandwidth and/or download bandwidth for each group via computing a system performance index, to achieve the balance of the performance of the data delivery system, as shown in step 1020.

In summary, the exemplary embodiments of the present disclosure provide a mechanism for hybrid P2P and client-server data transmission, applicable to a data delivery system. Via the peer grouping method, a plurality of peers connected to an original source for transmitting/receiving is divided into a P2P group and a client-server group. During data transmission process, via the computation of a system performance index, the mechanism dynamically determines the respective number of peers in each group and adjusts the available upload bandwidth to achieve a performance balance of the data delivery system.

Although the present disclosure has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An architecture for hybrid Peer-to-Peer (P2P)/client-server data transmission, applicable to a data delivery system, said architecture comprising:
an original source; and
a plurality of peers connected to said original source for transmitting/receiving data;
wherein said original source determines said plurality of connected peers are transmitting data in either P2P mode or client-server mode, divides said plurality of connected peers into a P2P group and a client-server group, and dynamically determines respective number of peers in said P2P group and said client-server group and adjusts respective available upload/download bandwidth for each of said two group.

2. The architecture as claimed in claim 1, wherein said original source is connected to a data source and transmits data from said data source to said P2P group and said client-server group.

3. The architecture as claimed in claim 1, wherein said client-server group includes n peers, n≧0, when n≧1, each of said n peers downloads or streams one or more required data segments directly from said original source.

4. The architecture as claimed in claim 1, wherein said P2Pr group comprises m peers, m≧0, when m≧1, data segments owned by each of said m peers are from one or more neighboring peers or directly from said original source.

5. The architecture as claimed in claim 2, said architecture considers transmission delay in P2P transmission process, limitation on upload bandwidth of said original source, network throughput and system loading, and uses a peer grouping method to let said original source to determine data transmission mode for said plurality of connected peers.

6. The architecture as claimed in claim 1, wherein said original source dynamically determines respective number of peers in said P2P group and said client-server group and adjusts allocated upload bandwidth to achieve a performance balance of said data delivery system.

7. An architecture for hybrid Peer-to-Peer (P2P)/client-server data transmission, applicable to a data transmission system, said architecture comprising:
an original source, said original source connect to a data source having data via a Universal Serial Bus (USB) or a wireless network; and
a plurality of peers connected to said original source for transmitting/receiving data, said plurality of peers being divided into a P2P group and a client-server group;
wherein said original source transmits data from said data source via at least a network interface to said P2P group and said client-server group.

8. The architecture as claimed in claim 7, wherein said original source is an embedded computing device, and format of said data is any combination of video, audio and images media formats, said original source uses a media format conversion method to convert said format data into another format.

9. A method for hybrid Peer-to-Peer (P2P)/client-server data transmission, applicable to a data transmission system, said method comprising:
an original source determining whether a plurality of newly connected peers transmitting data in P2P mode or in client-server mode via a peer grouping method, and dividing said plurality of connected peers into a P2P group and a client-server group; and
during a data transmission process, said original source dynamically determining the number of peers of each group and adjusting an available upload bandwidth and/or download bandwidth for each of said two groups via computing a system performance index, to achieve the balance of the performance of said data delivery system.

10. The method as claimed in claim 9, said method defines said system performance index by considering system loading of said original source, respective average transmission delay in said client-server group and in said P2P group, network throughput and respective number of peers in each of said two groups connected to said original source.

11. The method as claimed in claim 10, wherein said peer grouping method further includes:
within a range of system loading, obtaining extreme values of n and U1 that maximize said system performance index by using a multi-variable function, wherein n is number of peers in said client-server group and U1 is total upload bandwidth assigned to said client-server group.

12. The method as claimed in claim 11, wherein aid peer grouping method further includes:
according to comparison between said obtained extreme value of n and current number of peers in said client-server group, determining whether to move peers from said P2P group or to said P2P group.

13. The method as claimed in claim 11, wherein said system loading is a utilization rate of at least a central processing unit of said original source, a utilization rate of at least a physical or virtual memory, number of times of accesses or transmission throughput of hard disk or network card, or a function of any combination of the above.

14. The method as claimed in claim 10, wherein at least a peer in said client-server group, according to information of time stamp included in at least a packet sent by said original source, refers to said information of time stamp of at least a received packet to compute transmission delay, and returns the computed result directly to said original source for statistic computation to obtain average transmission delay in said client-server group.

15. The method as claimed in claim 10, wherein each peer in said P2P group, according to information of time stamp included in at least a packet sent by said original source, refers to said information of time stamp of at least a received packet to compute transmission delay, and passes the computed result to a super peer in said P2P group for statistic computation to obtain average transmission delay in said P2P group, and said statistic on average transmission delay is then returned directly to said original source.

16. The method as claimed in claim 15, wherein said super peer is a peer selected from said P2P group, and is one of top k peers with larger upload bandwidth or more computing power in said P2P group, k is an integer less than the number of peers in said P2P group.

17. The method as claimed in claim 9, wherein each peer in said client-server group directly downloads or streams one or more required data segments from said original source.

18. The method as claimed in claim 9, wherein said P2P group includes m peers, m≦0, and when m 1, one or more data segments owned by each of said m peers are from one or more neighboring peers or directly from said original source.

19. The method as claimed in claim 18, wherein top i peers with larger upload bandwidth or more computing power in said P2P group are considered as super peers, 0<i<m, and one or more data segments owned by said super peers are from said original source, and one or more data segments owned by non-super peers are from any peers of said P2P group.
